(19) United States
(12) Patent Application Publication
(10) Pub. No.: US 2023/0016737 A1
(43) Pub. Date: Jan. 19, 2023

(54) UPDATING CONFIGURATION FOR EARLY DATA TRANSMISSION

(71) Applicant: NOKIA TECHNOLOGIES OY, Espoo (FI)

(72) Inventors: Dongsheng FAN, Nanjing, Jiangsu (CN); Yigang CAI, Naperville, IL (US)

(21) Appl. No.: 17/782,272

(22) PCT Filed: Dec. 3, 2019
(86) PCT No.: PCT/CN2019/122601

§ 371 Date: Jun. 3, 2022

(51) Int. Cl. H04L 1/18; H04L 1/00

(52) U.S. Cl. CPC H04L 1/1896; H04L 1/1812; H04L 1/0057

(57) ABSTRACT

Embodiments of the present disclosure relate to updating configuration for early data transmission. According to embodiments of the present disclosure, updating configuration for early data transmission is proposed. According to embodiments of the present disclosure, the network device generates records for the early data transmission from the terminal device. The network device transmits the record to the managing device. The managing device updates the configuration for the early data transmission based on the record. In this way, the configurations for the early data transmission can be updated dynamically. The waste on the resources can be avoided and the power at the terminal device can be saved.

### FIELD

Embodiments of the present disclosure generally relate to communication techniques, and more particularly, to methods, devices and computer readable medium for updating configuration for early data transmission.

### BACKGROUND

With developments of communication systems, new technologies have been proposed. For example, the third generation partnership project (3GPP) has introduced early data transmission (EDT) for enhanced machine type communication (eMTC) to save power of eMTC user. It allows eMTC user to transmit uplink user data in message 3 (MGS3).

### SUMMARY

Generally, embodiments of the present disclosure relate to a method for updating configuration for early data transmission and corresponding devices.

In a first aspect, there is provided a method. The method comprises obtaining, at a first device, first configuration information for early data transmission, the first configuration information indicating a first number of total resource blocks to be used by a second device for the early data transmission and a second number of allowable resource blocks. The method further comprises transmitting, at the first device, the first configuration information to a third device. The method also comprises receiving, at the first device, usage information of the total resource blocks from the third device. The method yet comprises determining, at the first device, second configuration information based at least on the usage information and the first configuration information, the second configuration information indicating a target number of total resource blocks and a target number of allowable resource blocks.

In a second aspect, there is provided a method. The method comprises transmitting, at a third device and to a second device, first configuration information for early data transmission received from a first device, the first configuration information indicating a first number of total resource blocks to be used by the second device for the early data transmission and a second number of allowable resource blocks. The method also comprises receiving, at the third device, the early data transmission from the second device. The method further comprises generating, at the third device, usage information of the total resource blocks based at least on the early data transmission. The method yet comprises transmitting, at the third device, the usage information to the first device.

In a third aspect, there is provided a method. The method comprises receiving, at a second device and from a third device, first configuration information for early data transmission, the first configuration information indicating a first number of total resource blocks to be used by the second device for the early data transmission and a second number of allowable resource blocks. The method further comprises in accordance with a determination that data is to be transmitted, determining, at the second device, whether the data is suitable for the early data transmission based on an amount of the data and the first number of total resource blocks. The method yet comprises in accordance the data is suitable for the early data transmission, transmitting, at the second device, the data to the third device based on the first configuration information.

In a fourth aspect, there is provided a first device. The first device comprises at least one processor; and at least one memory including computer program codes; the at least one memory and the computer program codes are configured to, with the at least one processor, cause the first device to obtain first configuration information for early data transmission, the first configuration information indicating a first number of total resource blocks to be used by a second device for the early data transmission and a second number of allowable resource blocks. The first device is also caused to transmit the first configuration information to a third device. The first device is further caused to receive usage information of the total resource blocks from the third device. The first device is yet caused to determine second configuration information based at least on the usage information and the first configuration information, the second configuration information indicating a target number of total resource blocks and a target number of allowable resource blocks.

In a fifth aspect, there is provided a third device. The third device comprises at least one processor; and at least one memory including computer program codes; the at least one memory and the computer program codes are configured to, with the at least one processor, cause the third device to transmit, to a second device, first configuration information for early data transmission received from a first device, the first configuration information indicating a first number of total resource blocks to be used by the second device for the early data transmission and a second number of allowable resource blocks. The third device is also caused to receive the early data transmission from the second dev. The third device is further caused to generate usage information of the total resource blocks based at least on the early data transmission. The third device is yet caused to transmit the usage information to the first device.

In a sixth aspect, there is provided a second device. The second device comprises at least one processor; and at least one memory including computer program codes; the at least one memory and the computer program codes are configured to, with the at least one processor, cause the second device to receive, and from a third device, first configuration information for early data transmission, the first configuration information indicating a first number of total resource blocks to be used by the second device for the early data transmission and a second number of allowable resource blocks. The second device is also caused in accordance with a determination that data is to be transmitted, determine whether the data is suitable for the early data transmission based on an amount of the data and the first number of total resource blocks. The second device is further caused to in accordance the data is suitable for the early data transmission, transmit the data to the third device based on the first configuration information.

In a seventh aspect, there is provided an apparatus. The apparatus comprises means for performing at least the method according to the above first, second, or third aspect.

In an eighth aspect, there is provided a computer readable medium comprising program instructions for causing an apparatus to perform at least the method according to the above first, second, or third aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates a schematic diagram of a communication system according to embodiments of the present disclosure;

FIG. 2 illustrates a schematic diagram of interactions between devices according to embodiments of the present disclosure;

FIG. 3 illustrates a flow chart of a method according to embodiments of the present disclosure;

FIG. 4 illustrates a flow chart of a method according to embodiments of the present disclosure;

FIG. 5 illustrates a flow chart of a method according to embodiments of the present disclosure;

FIG. 6 illustrates a flow chart of a method according to embodiments of the present disclosure;

FIG. 7 illustrates a flow chart of a method according to embodiments of the present disclosure;

FIG. 8 illustrates a schematic diagram of a pattern period according to embodiments of the present disclosure;

FIG. 9 illustrates a flow chart of a method according to embodiments of the present disclosure;

FIG. 10 illustrates a flow chart of a method according to embodiments of the present disclosure;

FIG. 11 illustrates a flow chart of a method according to embodiments of the present disclosure;

FIG. 12 illustrates a simplified block diagram of an apparatus that is suitable for implementing embodiments of the present disclosure; and

FIG. 13 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:

(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT), New Radio (NR) and so on. Furthermore, the communications between a terminal device and a network device in the communication network may be performed according to any suitable generation communication protocols, including, but not limited to, the first generation (1G), the second generation (2G), 2.5G, 2.65G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As mentioned above, the third generation partnership project (3GPP) has introduced early data transmission (EDT) for enhanced machine type communication eMTC) to save power of eMTC user. It allows eMTC user to transmit uplink user data in message 3 (MGS3). The EDT parameters can be configured and updated per coverage enhancement (CE)-Level, they are broadcast periodically in system information block (SIB) 2, like below description:

edt-LastPreamble

This parameter provides the mapping of preambles to groups for each CE level for EDT. For the concerned CE level, if PRACH resources configured by edt-PRACH-ParametersCE-r15 are different from the PRACH resources configured by PRACH-ParametersCE-r13 for all CE levels and edt-PRACH-ParametersCE-r15 for all other CE levels, the preambles for EDT are the preambles firstPreamble-r13 to edt-LastPreamble-r15, otherwise the preambles for EDT are the preambles lastPreamble-r13+1 to edt-LastPreamble-r15.

edt-SmallTBS-Enabled

Value TRUE indicates UE performing EDT is allowed to select TBS smaller than edt-TBS for Msg3 in the corresponding CE level.

edt-SmallTBS-Subset

Presence indicates only two of the TBS values can be used according to edt-TBS corresponding to the CE level. When the field is not present, any of the TBS values according to edt-TBS corresponding to the CE level can be used. This field is applicable for a CE level only when edt-SmallTBS-Enabled is included for the corresponding CE level.

edt-TBS

Largest TBS for Msg3 for a CE level applicable to a UE performing EDT. Value is in bits. Value b328 corresponds to 328 bits, b408 corresponds to 408 bits and so on. Additionally, value b1000 or 456 corresponds to 1000 bits for CE levels 0 and 1, and 456 bits for CE levels 2 and 3.

mac-ContentionResolutionTimer

Timer for contention resolution is defined in TS 36.321 [6] Value is in subframes. Value sf8 corresponds to 8 subframes, sf16 corresponds to 16 subframes and so on. mac-ContentionResolutionTimer-r15 is only applicable for EDT. UE performing EDT shall use mac-ContentionResolutionTimer-r15, if present.

When preamble for EDT is detected, the network device may make decision to use normal random access response (RAR) or EDT-RAR for this preamble. EDT-RAR may assign much more resource than normal RAR. EDT-RAR is indicated by “R” bit in MAC-RAR. Descriptions in TS36.213-f60 are as below:

MAC payload for Random Access Response

The MAC RAR is of fixed size and consists of the following fields:

R: Reserved bit, set to “0”. For a terminal device in CE, this bit is set to “1” to indicate that an UL Grant in Random Access Response is for EDT

EDT-RAR format is like below Table from TS36.213-f60, and modulation order is set to 2:

TABLE 6.2-F
Random Access Response Grant Content field
size for EDT

| DCI contents | CEmodeA | CEmodeB |
|---|---|---|
| Msg3 PUSCH | N_{NB}^{index} | 3 |
| narrowband index | | |
| Msg3 PUSCH | 5 | 3 |
| Resource allocation | | |
| Number of | | |
| Repetitions for Msg3 | 2 | 3 |
| PUSCH | | |
| TPC | 3 | 0 |
| CSI request | 1 | 0 |
| UL delay | 1 | 0 |
| Msg3/4 MPDCCH | N_{NB}^{index} | 3 |
| narrowband index | | |
| Zero padding | 8 − 2 · N_{NB}^{index} | 0 |
| Total Nr-bits | 20 | 12 |

The terminal device selects transport block size (TBS) according to EDT parameters from the following table in TS36.213-f60:

TABLE 8.6.2-1
EDT TBS for CEModeA with edt-SmallTBS-
Enabled-r15 set to “true”.

| edt-TBS- | edt-SmallTBS- | Allowable TBS |
|---|---|---|
| r15 | Subset-r15 | values |
| 408 | not configured | 328, 408 |
| 504 | not configured | 328, 408, 456, 504 |
| 504 | enabled | 408, 504 |
| 600 | not configured | 328, 408, 504, 600 |
| 600 | enabled | 408, 600 |
| 712 | not configured | 328,456, 600,712 |
| 712 | enabled | 456,712 |
| 808 | not configured | 328,504,712, 808 |
| 808 | enabled | 504, 808 |
| 936 | not configured | 328,504,712, 936 |
| 936 | enabled | 504, 936 |
| 1000 | not configured | 328, 536, 776, 1000 |
| 1000 | enabled | 536, 1000 |

TABLE 8.6.2-2
EDT TBS for CEModeB with edt-SmallTBS-
Enabled-r15 set to “true”.

| edt-TBS- | edt-SmallTBS- | Allowable TBS |
|---|---|---|
| r15 | Subset-r15 | values |
| 408 | not configured | 328, 408 |
| 456 | not configured | 328, 408, 456 |
| 456 | enabled | 408, 456 |
| 504 | not configured | 328, 408, 456, 504 |
| 504 | enabled | 408, 504 |
| 600 | not configured | 328, 408, 504, 600 |
| 600 | enabled | 408, 600 |
| 712 | not configured | 328,456, 600,712 |
| 712 | enabled | 456,712 |
| 808 | not configured | 328,504,712, 808 |
| 808 | enabled | 504, 808 |
| 936 | not configured | 328,504,712, 936 |
| 936 | enabled | 504, 936 |

The network device may decode the physical uplink shared channel (PUSCH) according to EDT configuration. If “edt-SmallTBS-Enabled-r15” is true, the network device must try to decode it for each allowable TBS value; if “edt-SmallTBS-Enabled-r15” is not present, TBS is given by parameter “edt-TBS”.

It is difficult for customer to forecast data size of each CE-Level for EDT. And one fixed TBS is hard to cover all the user cases, and this will take disadvantage to EDT function, such as small TBS will cancel EDT function in user side, large may bring much padding and waste resource. So, a dynamic algorithm is needed (and maybe unavoidable) to adjust EDT parameters according to the real user case.

According to embodiments of the present disclosure, updating configuration for early data transmission is proposed. According to embodiments of the present disclosure, the network device generates records for the early data transmission from the terminal device. The network device transmits the record to the managing device. The managing device updates the configuration for the early data transmission based on the record. In this way, the configurations for the early data transmission can be updated dynamically. The waste on the resources can be avoided and the power at the terminal device can be saved.

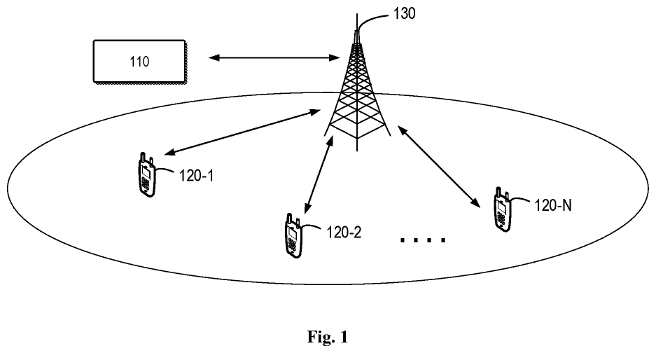

FIG. 1 illustrates a schematic diagram of a communication system in which embodiments of the present disclosure can be implemented. The communication system 100, which is a part of a communication network, comprises a device 120-1, a device 120-2, . . . . , a device 120-N, which can be collectively referred to as “second device(s) 120.” The communication system 100 further comprises a third device 130. One or more devices are associated with and covered by a cell. It is to be understood that the number of devices and cells shown in FIG. 1 is given for the purpose of illustration without suggesting any limitations. The communication system also comprises a first device 110. In some embodiments, the first device 110 may be a core network device. The first device 110 may be an entity or a virtual network function. In some embodiments, the first device 110 may also be implemented on the third device 130.

In the communication system 100, the first device 110 and the third device 130 can communicate with each other. In the case that the second device 120 is the terminal device and the third device 130 is the network device, a link from the third device 130 to the second device 120 is referred to as a downlink (DL), while a link from the second device 120 to the third device 130 is referred to as an uplink (UL). The number of devices shown in FIG. 1 is given for the purpose of illustration without suggesting any limitations. It also should be noted that the second device 120 and the third device 130 can be interchangeable.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

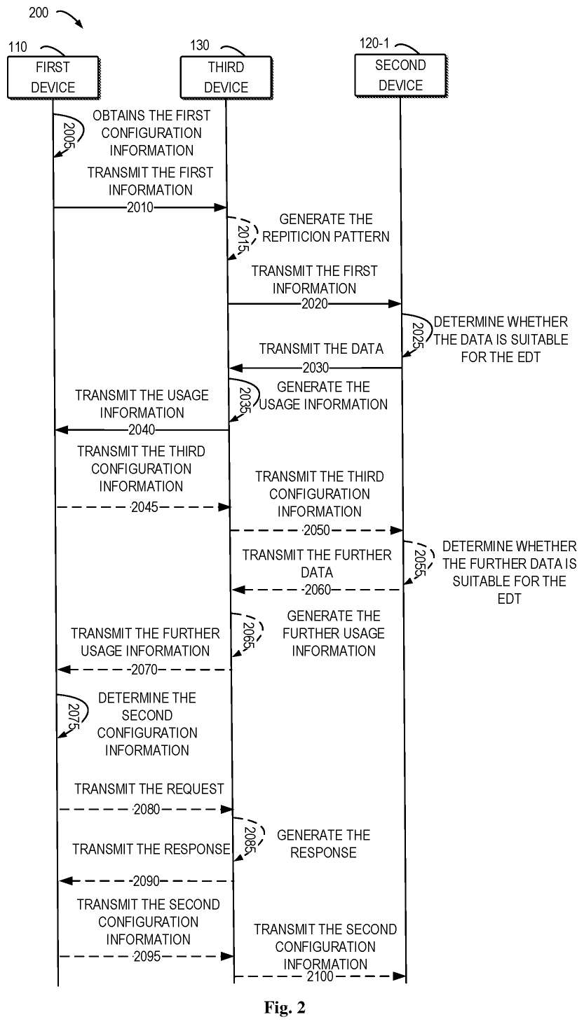

FIG. 2 illustrates a schematic diagram of interactions 200 among devices in accordance with embodiments of the present disclosure. The interactions 200 may be implemented at any suitable devices. Only for the purpose of illustrations, the interactions 200 are described to be implemented at the first device 110, the second device 120-1, and the third device 130.

The first device 110 obtains 2005 first configuration information for the EDT. The first configuration indicates the number of total resource blocks and the number of allowable resource blocks. For example, the first configuration may indicate that the length of total bits for the EDT is 600 bits. The length of allowable bits may be 600. In some embodiments, the lengths of allowable bits may be 328, 408, 504 and 600. In other embodiments, the lengths of allowable bits may be 408 and 600. Table 1 and Table 2 below show possible configurations for the EDT.

TABLE 1
EDT TBS priority table for CEModeA

| | Sub- | edt- | edt-SmallTBS- | edt-SmallTBS- | Allowable |
|---|---|---|---|---|---|
| Index | Index | TBS | Subset | Enabled | TBS values |
| 0 | 0 | 328 | not configured | not configured | 328 |
| 1 | 0 | 408 | not configured | not configured | 408 |
| 1 | 1 | 408 | not configured | enbaled | 328, 408 |
| 2 | 0 | 504 | not configured | enbaled | 328, 408, 456, |
| | | | | | 504 |
| 2 | 1 | 504 | enabled | enbaled | 408, 504 |
| 2 | 2 | 504 | not configured | not configured | 504 |
| 3 | 0 | 600 | not configured | enbaled | 328, 408, 504, |
| | | | | | 600 |
| 3 | 1 | 600 | enabled | enbaled | 408, 600 |
| 3 | 2 | 600 | not configured | not configured | 600 |
| 4 | 0 | 712 | not configured | enbaled | 328, 456, 600, |
| | | | | | 712 |
| 4 | 1 | 712 | enabled | enbaled | 456,712 |
| 4 | 2 | 712 | not configured | not configured | 712 |
| 5 | 0 | 808 | not configured | enbaled | 328, 504, 712, |
| | | | | | 808 |
| 5 | 1 | 808 | enabled | enbaled | 504, 808 |
| 5 | 2 | 808 | not configured | not configured | 808 |
| 6 | 0 | 936 | not configured | enbaled | 328, 504, 712, |
| | | | | | 936 |
| 6 | 1 | 936 | enabled | enbaled | 504, 936 |
| 6 | 2 | 936 | not configured | not configured | 936 |
| 7 | 0 | 1000 | not configured | enbaled | 328, 536, 776, |
| | | | | | 1000 |
| 7 | 1 | 1000 | enabled | enbaled | 536,1000 |
| 7 | 2 | 1000 | not configured | not configured | 1000 |

TABLE 2
EDT TBS priority table for CEModeB

| | Sub- | edt- | edt-SmallTBS- | edt-SmallTBS- | Allowable |
|---|---|---|---|---|---|
| Index | Index | TBS | Subset | Enabled | TBS values |
| 0 | 0 | 328 | not configured | not configured | 328 |
| 1 | 0 | 408 | not configured | not configured | 408 |
| 1 | 1 | 408 | not configured | enbaled | 328, 408 |
| 2 | 0 | 456 | not configured | enbaled | 328, 408, 456 |
| 2 | 1 | 456 | enabled | enbaled | 408,456 |
| 2 | 2 | 456 | not configured | not configured | 456 |
| 3 | 0 | 504 | not configured | enbaled | 328, 408, 456, |
| | | | | | 504 |
| 3 | 1 | 504 | enabled | enbaled | 408, 504 |
| 3 | 2 | 504 | not configured | not configured | 504 |
| 4 | 0 | 600 | not configured | enbaled | 328, 408, 504, |
| | | | | | 600 |
| 4 | 1 | 600 | enabled | enbaled | 408, 600 |
| 4 | 2 | 600 | not configured | not configured | 600 |
| 5 | 0 | 712 | not configured | enbaled | 328, 456, 600, |
| | | | | | 712 |
| 5 | 1 | 712 | enabled | enbaled | 456,712 |
| 5 | 2 | 712 | not configured | not configured | 712 |
| 6 | 0 | 808 | not configured | enbaled | 328, 504, 712, |
| | | | | | 808 |
| 6 | 1 | 808 | enabled | enbaled | 504, 808 |
| 6 | 2 | 808 | not configured | not configured | 808 |
| 7 | 0 | 936 | not configured | enbaled | 328, 504, 712, |
| | | | | | 936 |
| 7 | 1 | 936 | enabled | enbaled | 504, 936 |
| 7 | 2 | 936 | not configured | not configured | 936 |

In some embodiments, the first configuration may be obtained from customers. Alternatively or in addition, the first configuration may be default configuration. The first device 110 transmits 2010 the first configuration to the third device 130.

The third device 130 transmits 2020 the first configuration to the second device 120-1. For example, the third device 130 may broadcast the first configuration periodically in SIB 2. In some embodiments, the third device 130 may generate 2015 a repetition pattern and transmit the repetition pattern along with the first configuration to second device 120-1. The repetition pattern may include a plurality of available resource blocks and a plurality of time slots. For example, only one resource block is available at one time and the time slot is known between the third device 130 and the second device 120-1. Table 3 below shows codes for the repetition pattern.

TABLE 3

| | |
|---|---|
| [[ edt-Pattern-r15 | SEQUENCE { |
| edt-LastPreamble-r15 | INTEGER(0..63), |

| | |
|---|---|
| edt-Pattern-Period-r15 | ENUMERATED {day1, day2, day8, day 10, day 15, |

day30, day60, day90},
mac-ContentionResolutionTimer-r15 ENUMERATED {sf240, sf480,
sf960,

| | | | sf1920, sf3840, sf5760, |
|---|---|---|---|
| sf7680, sfl0240} | OPTIONAL -- Need OP | | |
| } | OPTIONAL | -- Cond EDT | |

]]

where edt-Pattern-Period is period of EDT repetition pattern. Value day1 corresponds to 1 day, day2 corresponds to 2 days. This period contains eight slots, time duration of each slot is ⅛ edt-Pattern-Period. Each available resource block in increase order occupies a time slot. For CE ModeA, they are {b328, b408, b504, b600, b712, b808, b936, b1000}, for CE ModeB, they are {b328, b408, b504, b600, b712, b808, b936, b456}.

If the second device 120-1 needs to transmit data to the third device 130, the second device 120-1 may determine whether the data can be transmitted as the early data transmission based on the amount of the data and the first configuration. The second device 120-1 transmits 2030 the data to the third device 130. For example, if the length of total bits for the EDT is 600 and the amount of data is no more than 600 bits, the data can be transmitted as the EDT. In other embodiments, if the first configuration information indicates that the length of total bits for the EDT is 600 and the lengths of allowable bits are 328, 408, 504 and 600, and the amount of data is 400 bits, the third device 130 may select 408 bits and transmit the data using the 408 bits with padding.

The third device 130 generates 2035 the usage information of the total resource blocks allocated for the EDT. The usage information may comprises one or more of: the number of total early data transmissions during a period of time, the number of successful early data transmissions during the period of time, the number of hybrid automatic repeat request (HARQ) processes during the period of time, and the number of resource blocks used by the second device during the period of time. Table 4 below shows example EDT record for one EDT.

TABLE 4
EDT Record

| | |
|---|---|
| Time | Time when eNB detect preamble |
| CeMode | CE ModeA or CE ModeB |
| PreambleID | Preamble id |
| MSG3HarqStatus | MSG3 Harq is successful or not |
| MSG3HarqTransNumber | MSG3 Harq transmission number |
| TBS | MAC PDU size in MSG3 without |
| | Padding, only for successful msg3 Harq |

The third device 130 may generate the usage information for the first configuration based on the EDT records. Table 5 below shows example usage information for the first configuration.

TABLE 5
ZDT statistic message

| | |
|---|---|
| EdtPrachNumber | EDT attempt number among this period |
| EdtFailureNumber | EDT successful number among this period |
| EdtPrachRecord[ . . . ] | EDT Prach records among this period |

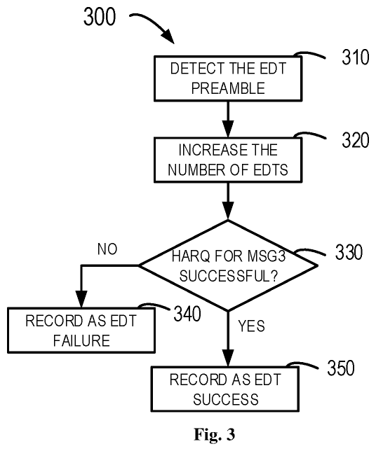

With reference to FIG. 3, FIG. 3 illustrates a method 300 for generating the usage information according to an example embodiment of the present disclosure.

At block 310, the third device 130 detects the EDT preamble. The third device 310 increases, at block 320, the number of EDTs. At block 330, the third device 130 determines whether the HARQ for MSG3 is successful. If the HARQ for MSG3 is not successful, the third device 130 records the EDT as a failure at block 340. If the HARQ for MSG3 is successful, the third device 130 records the EDT as success at block 350.

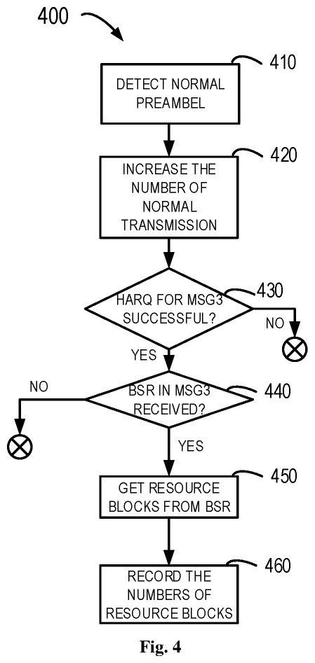

FIG. 4 illustrates a method 400 for generating the usage information according to a further example embodiment of the present disclosure.

At block 410, the third device 130 detects the normal preamble. The third device 310 increases, at block 420, the number of normal transmissions. At block 430, the third device 130 determines whether the HARQ for MSG3 is successful. If the HARQ for MSG3 is not successful, the third device 130 may not record this transmission. If the HARQ for MSG3 is successful, the third device 130 determines whether the buffer status report (BSR) in MSG3 is received at block 440. If the BSR is not received, the third device 130 may not record this transmission. If the BSR is received, the third device 130 obtains the resource blocks from the BSR. At block 460, the third device 130 record the number of resource blocks in the BSR.

Referring back to FIG. 2, the third device 130 transmits 2040 the usage information to the first device 110. The first device 110 determines 2075 the second configuration information based at least on the usage information. The first device 110 may perform polling to determine the second configuration information. In this way, the configurations for the early data transmission can be updated dynamically. The waste on the resources can be avoided and the power at the terminal device can be saved.

For example, if the first configuration information indicates that the number of total resource blocks is 600, the first device 110 may transmit 2045 the third configuration information which indicates that the number of total resource blocks is 712. The third information may indicate another number of total resource blocks and another number of allow resource blocks. The third device 130 may transmit 2050 the third information to the second device 120-1. If the second device needs to transmit further data, the second device 120-1 may determine 2055 whether the further data is suitable for the EDT based on the amount of the further data and the third configuration information. The second device 120-1 may transmit 2060 the further data to the third device 130. The third device 130 may generate 2065 the further usage information based on the further data. The further usage information may be generated in a similar way as generating the usage information. The third device 130 may transmit 2070 the further usage information to the first device 110.

In this situation, the first device 110 may determine the second configuration information based on correlation between the usage information and the further usage information. For example, if the number of successful EDTs in the further usage information is bigger than the number of successful EDTs in the usage information, the first device 110 may determine the third configuration information to be the second configuration information.

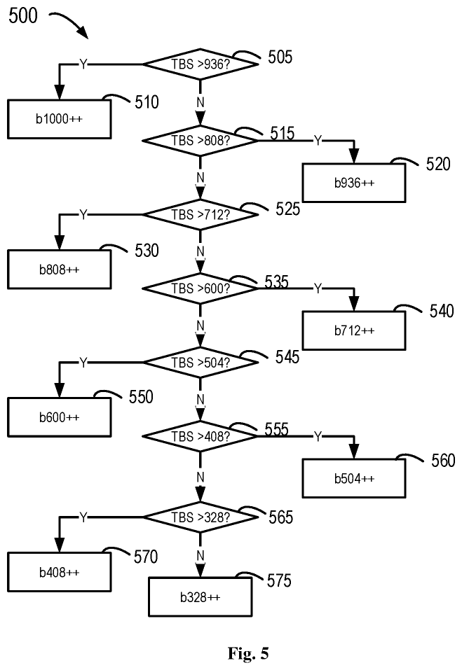

In other embodiments, the first device 110 may update the first configuration information to be the second configuration information based on the usage information. For example, the first device 110 may calculate the resource block distribution from the usage information. FIG. 5 illustrates a method 500 for determining the number resource blocks distribution for CE mode A. For the purpose of illustrations, the first device 110 may obtain transport block sizes (TBS) for the EDT from the usage information. Only for the purpose of illustrations, the TB hereinafter refers to the resource block. It should be noted that the resource block may include any suitable kinds of resource blocks.

At block 505, the first device 100 may determine whether the TBS is bigger than 936 bits. If the TBS is bigger than 936 bits, the first device 110 may, at block 510, count one for TBS being 1000 bits. If the TBS is smaller than 936 bits, the first device 100 may, at block 515, determine whether the TBS is bigger than 808 bits. If the TBS is bigger than 808 bits, the first device 110 may, at block 520, count one for TBS being 936 bits. If the TBS is smaller than 808 bits, the first device 100 may, at block 525, determine whether the TBS is bigger than 712 bits. If the TBS is bigger than 712 bits, the first device 110 may, at block 530, count one for TBS being 808 bits. If the TBS is smaller than 712 bits, the first device 100 may, at block 535, determine whether the TBS is bigger than 600 bits. If the TBS is bigger than 600 bits, the first device 110 may, at block 540, count one for TBS being 712 bits. If the TBS is smaller than 600 bits, the first device 100 may, at block 545, determine whether the TBS is bigger than 504 bits. If the TBS is bigger than 504 bits, the first device 110 may, at block 550, count one for TBS being 600 bits. If the TBS is smaller than 504 bits, the first device 100 may, at block 555, determine whether the TBS is bigger than 408 bits. If the TBS is bigger than 408 bits, the first device 110 may, at block 560, count one for TBS being 504 bits. If the TBS is smaller than 408 bits, the first device 100 may, at block 565, determine whether the TBS is bigger than 328 bits. If the TBS is bigger than 328 bits, the first device 110 may, at block 570, count one for TBS being 408 bits. If the TBS is smaller than 328 bits, the first device 100 may, at block 575, count one for TBS being 328 bits.

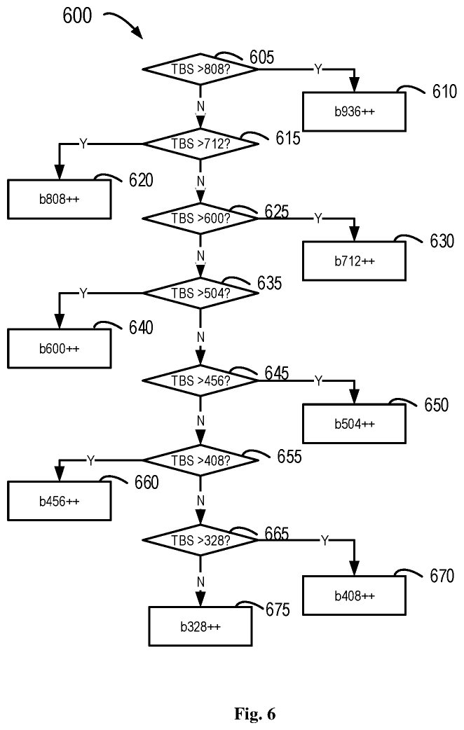

FIG. 6 illustrates a method 600 for determining the number resource blocks distribution for CE mode B.

At block 605, the first device 100 may determine whether the TBS is bigger than 808 bits. If the TBS is bigger than 808 bits, the first device 110 may, at block 610, count one for TBS being 936 bits. If the TBS is smaller than 808 bits, the first device 100 may, at block 615, determine whether the TBS is bigger than 712 bits. If the TBS is bigger than 712 bits, the first device 110 may, at block 620, count one for TBS being 808 bits. If the TBS is smaller than 712 bits, the first device 100 may, at block 625, determine whether the TBS is bigger than 600 bits. If the TBS is bigger than 600 bits, the first device 110 may, at block 630, count one for TBS being 712 bits. If the TBS is smaller than 600 bits, the first device 100 may, at block 635, determine whether the TBS is bigger than 504 bits. If the TBS is bigger than 504 bits, the first device 110 may, at block 640, count one for TBS being 600 bits. If the TBS is smaller than 504 bits, the first device 100 may, at block 645, determine whether the TBS is bigger than 456 bits. If the TBS is bigger than 465 bits, the first device 110 may, at block 650, count one for TBS being 504 bits. If the TBS is smaller than 456 bits, the first device 100 may, at block 655, determine whether the TBS is bigger than 408 bits. If the TBS is bigger than 408 bits, the first device 110 may, at block 660, count one for TBS being 456 bits. If the TBS is smaller than 408 bits, the first device 100 may, at block 665, determine whether the TBS is bigger than 328 bits. If the TBS is bigger than 328 bits, the first device 110 may, at block 670, count one for TBS being 408 bits. If the TBS is smaller than 328 bits, the first device 100 may, at block 675, count one for TBS being 328 bits.

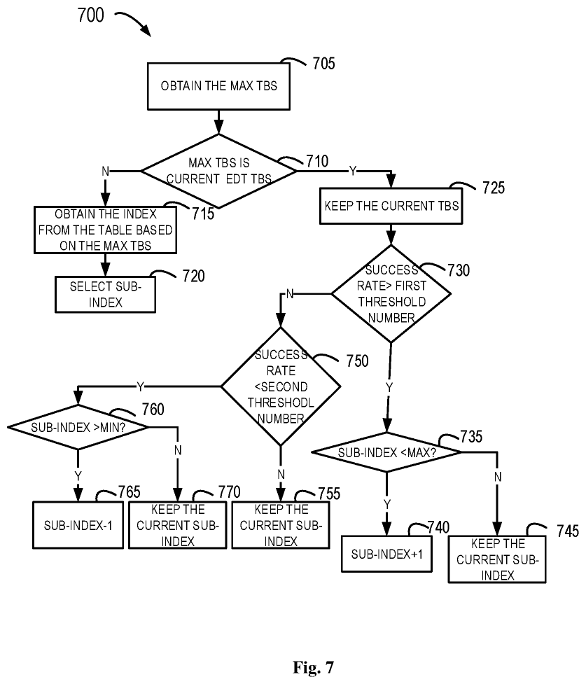

In an example embodiment, the first device 110 may determine the second configuration information for the EDT based on the max TBS and HARQ success rate in the usage information. As mentioned above, Table 1 and Table 2 show possible configurations for the EDT. The first device 110 may select the second configuration from Table 1 and Table 2 based on the usage information. FIG. 7 illustrates a method 700 for determining the second configuration information according to an embodiment of the present disclosure. Only for the purpose of illustrations, the method 700 is described with the reference to Table 1.

At block 705, the first device 110 obtains the max TBS from the usage information. At block 710, the first device 110 compares the max TBS with the TBS in the first configuration information. If the max TBS is different from the TBS in the first configuration information, the first device 110 obtains, at block 715, the index from Table 1 based on the max TBS and selects the sub-index from Table 1 at block 720. For example, if the max TBS is 504 and the current TBS in the first configuration information is 600, the target TBS in the second configuration information is 504. In some embodiments, the allowable TBS may be 328, 408, 456 and 504. Alternatively, the allowable TBS may be 504 only.

If the max TBS is the same as the TBS in the first configuration information, at block 725, the first device 110 keeps the current TBS to be the target TBS in the second configuration information. At block 730, the first device 110 compares the number of successful EDTs in the usage information with a first threshold number.

If the number of successful EDTs is higher than the first threshold number, the first device 110 compares the sub-index with the max sub-index in Table 1. If the sub-index is smaller than the max sub-index, the first device 110 at block 740 increases the sub-index value. If the sub-index is not smaller than the max sub-index, the first device 110 keeps the current sub-index at the block. In other words, if the number of successful EDTs is higher than the first threshold value, the first device 110 may decrease the allowable TBSs. For example, if the allowable TBSs are 408 and 600, the first device 110 decreases the allowable TBS to be 600.

If the number of successful EDTs is not higher than the first threshold number, at block 750, the first device 110 compares the number of successful EDTs with a second threshold number. If the number of successful EDTs is smaller than the second threshold number, the first device 110 at block 755 keeps the current sub-index, which means keep the current allowable TBS. If the number of successful EDTs is not smaller than the second threshold number, at block 760, the first device 110 compares the current sub-index with the minimum sub-index. If the current sub-index is bigger than the minimum sub-index, at block 765, the first device 110 decreases the sub-index value. If the current sub-index is not bigger than the minimum sub-index, at block 765, the first device 110 keeps the sub-index value. In other words, if the number of successful EDTs is not higher than the first threshold value, the first device 110 may increase the allowable TBSs. For example, if the allowable TBSs are 408 and 600, the first device 110 increases the allowable TBSs to be 328, 408, 504 and 600.

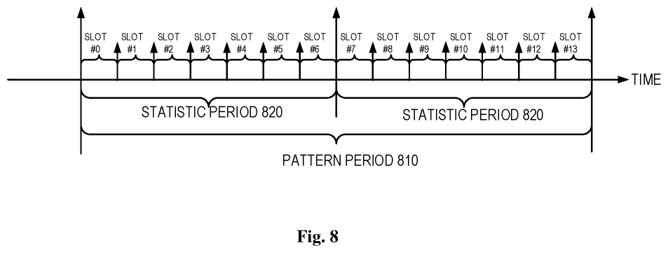

FIG. 8 illustrates a schematic diagram of a configuration pattern. If the first device 110 receives an EDT statistic message, it may calculate the time distribution among the pattern period 810. The pattern period 810 can contain N statistic periods, and the granularity can be daily or configured by customer. Only as an example, there are 14 time slots during the pattern period 810, slot #0, slot #1, slot #2, slot #3, slot #4, slot #5, slot #6, slot #7, slot #8, slot #9, slot #10, slot #11, slot #12, slot #13. The first device 110 may determine a target time slot at which most EDTs are transmitted, for example slot #6. The first device 110 may determine the second configuration for the target slot. The first device may transmit the request for updating the first configuration information at the beginning of the target time slot.

Referring back to FIG. 2, in some embodiments, the first device 11 may determine whether it is acceptable to change from the first configuration to the second configuration. If the change is allowed, the first device 110 may transmit 2080 the request for update the configuration to the third device 130. The third device 130 may generate 2085 the response to the request. The third device 130 may determine whether to accept the request based on its capacity. For example, the third device 130 may determine whether to accept the request based on its decoding effort and/or available resources. The third device 130 transmits 2090 the response to the first device 110. If the response indicates an acknowledgment, the first device transmits 2095 the second configuration information to the third device 130. The third device 130 may transmit 2100 the second configuration information to the first device 110.

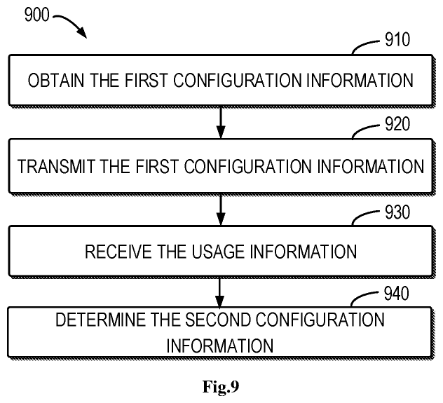

FIG. 9 illustrates a flow chart of method 900 according to embodiments of the present disclosure. The method 900 can be implemented at any suitable devices. For example, the method may be implemented at the first device 110.

At block 910, the first device 110 obtains first configuration information for early data transmission. The first configuration information indicates a first number of total resource blocks to be used by the second device 120-1 for the early data transmission and a second number of allowable resource blocks. In some embodiments, the first configuration may be obtained from customers. Alternatively or in addition, the first configuration may be default configuration.

At block 920, the first device 110 transmits the first configuration information to the third device 130.

At block 930, the first device 110 receives the usage information of the total resource blocks from the third device 130. The usage information may comprise one or more of: the number of total early data transmissions during a period of time, the number of successful early data transmissions during the period of time, the number of HARQ processes during the period of time, and the number of resource blocks used by the second device during the period of time.

At block 930, the first device 110 determines second configuration information based at least on the usage information and the first configuration information. The second configuration information indicates a target number of total resource blocks and a target number of allowable resource blocks.

In some embodiments, the first device 110 may determine a third number of resource blocks used by the second device based on the usage information. The first device 110 may compare the third number of resource blocks with the first number of total resource blocks. If the third number of resource blocks is different from the first number of total resource blocks, the first device 110 may determine that the target number of total resource blocks to be the third number of resource blocks.

In some embodiments, if the third number of resource blocks is the same as the first number of total resource blocks, the first device 110 may determine the number of successful early data transmission based on the usage information. The first device 110 may compare the number of successful early data transmission with a first threshold number. If the number of successful early data transmission exceeds the first threshold number, the first device 110 may decrease the second number of allowable resource blocks to a fourth number of allowable resource blocks. If the second number of allowable resource blocks cannot be decreased, the first device 110 may keep the second number of allowable resource blocks. The first device 110 may determine the target number of total resource blocks to be the third number of resource blocks and the target number of allowable resource blocks to be the fourth number of allowable resource blocks.

Alternatively or in addition, if the number of successful early data transmission is below the first threshold number, the first device 110 may compare the number of successful early data transmission with a second threshold number which is smaller than the first threshold number. If the number of successful early data transmission is below the second threshold number, the first device 110 may increase the second number of allowable resource blocks to a fifth number of allowable resource blocks. If the second number of allowable resource blocks cannot be increased, the first device 110 may keep the second number of allowable resource blocks. The first device 110 may determine the target number of total resource blocks to be the third number of resource blocks and the target number of allowable resource blocks to be the fifth number of allowable resource blocks.

In some embodiments, if the number of successful early data transmission is below the first threshold number, the first device 110 may compare the number of successful early data transmission with a second threshold number which is smaller than the first threshold number. If the number of successful early data transmission exceeds the second threshold number, the first device 110 may determine the target number of total resource blocks to be the third number of resource blocks and the target number of allowable resource blocks to be the second number of allowable resource blocks.

In some embodiments, the first device 110 may determine the second configuration information by polling. For example, the first device 110 may transmit third configuration information for early data transmission. The third configuration information may indicate a sixth number of total resource blocks to be used by the second for the early data transmission and a seventh number of allowable resource blocks. The first device 110 may receive from the third device 130 further usage information of the resource blocks. The first device may determine the second configuration information by comparing the usage information and the further usage information.

In some embodiments, the first device 110 may transmit an update request for the first configuration information to the third device 130. The first device 110 may receive a response to the update request. If the response indicates acknowledgement, the first device may transmit the second configuration information to the third device 130.

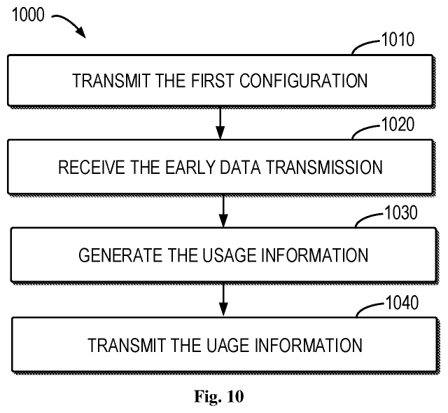

FIG. 10 illustrates a flow chart of method 1000. The method 1000 can be implemented at any suitable devices. For example, the method may be implemented at the third device 130.

At block 1010, the third device transmits the first configuration information for early data transmission to the second device 120-1. The first configuration information is received from the first device 110. The first configuration information indicates the first number of total resource blocks to be used by the second device 120-1 for the early data transmission and the second number of allowable resource blocks.

In some embodiments, the third device 130 may determine a repetition pattern. The repetition pattern may comprise a plurality of time slots for the early data transmission and a plurality of available resource blocks. The third device 130 may transmit the first configuration information along with the repetition pattern.

At block 1020, the third device 130 receives the early data transmission from the second device 120-1. In some embodiments, the third device 130 may also receive data transmitted in normal process not the EDT.

At block 1030, the third device 130 generates the usage information of the total resource blocks based at least on the early data transmission. The usage information may comprise one or more of: the number of total early data transmissions during a period of time, the number of successful early data transmissions during the period of time, the number of HARQ processes during the period of time, and the number of resource blocks used by the second device during the period of time.

In some embodiments, the third device 130 may receive buffer status report from the second device 120-1. The third device may generate the usage information based on the buffer status report and the early data transmission.

At block 1040, the third device 130 transmits the usage information of the total resource blocks to the first device 110. In some embodiments, the third device 130 may receive an update request for the first configuration from the first device 110. The third device 130 may generate a response to the update request based on a capacity of the third device 130. The third device 130 may transmit the response to the first device 110.

If the response indicates an acknowledgment, the third device 130 may receive the second configuration information based at least on the usage information and the first configuration information. The second configuration information may indicate a target number of total resource blocks and a target number of allowable resource blocks.

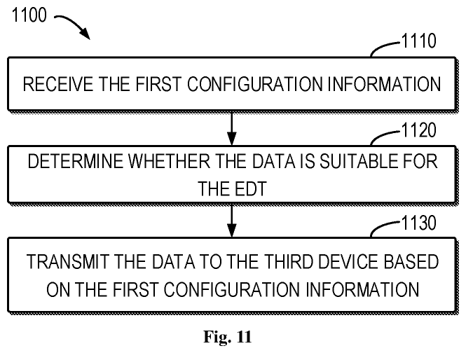

FIG. 11 illustrates a flow chart of method 1100. The method 1100 can be implemented at any suitable devices. For example, the method may be implemented at the second device 120-1.

At block 1110, the second device 120-1 receives the first configuration information for the EDT from the third device 130. The first configuration indicates the number of total resource blocks and the number of allowable resource blocks. In some embodiments, the second device 120-1 may receive a repetition pattern along with the first configuration information. The repetition pattern may comprise a plurality of time slots for the early data transmission and a plurality of available resource blocks.

At block 1120, if there data to be transmitted, the second device 120-1 determines whether the data is suitable for the EDT based amount of the data and the first number of total resource blocks.

At block 1130, if the data is suitable for the EDT, the second device 120-1 transmits the data to the third device based on the first configuration information.

In some embodiments, an apparatus for performing the method 900 (for example, the first device 110) may comprise respective means for performing the corresponding steps in the method 900. These means may be implemented in any suitable manners. For example, it can be implemented by circuitry or software modules.

In some embodiments, the apparatus comprises means for obtaining, at a first device, first configuration information for early data transmission, the first configuration information indicating a first number of total resource blocks to be used by a second device for the early data transmission and a second number of allowable resource blocks; means for transmitting the first configuration information to a third device; means for receiving usage information of the total resource blocks from the third device; and means for determining second configuration information based at least on the usage information and the first configuration information, the second configuration information indicating a target number of total resource blocks and a target number of allowable resource blocks.

In some embodiments, the usage information comprises one or more of: the number of total early data transmissions during a period of time, the number of successful early data transmissions during the period of time, the number of hybrid automatic repeat request, HARQ, processes during the period of time, and the number of resource blocks used by the second device during the period of time.

In some embodiments, the means for determining the second configuration information comprises: means for determining a third number of resource blocks used by the second device based on the usage information; means for comparing the third number of resource blocks with the first number of total resource blocks; and means for in accordance that the third number of resource blocks is different from the first number of total resource blocks, determining that the target number of total resource blocks to be the third number of resource blocks.

In some embodiments, the means for determining the second configuration information comprises: means for determining a third number of resource blocks used by the second device based on the usage information; means for comparing the third number of resource blocks with the first number of total resource blocks; means for in accordance that the third number of resource blocks is the same as the first number of total resource blocks, determining the number of successful early data transmission based on the usage information; means for comparing the number of successful early data transmission with a first threshold number; means for in accordance with a determination that the number of successful early data transmission exceeds the first threshold number, decreasing the second number of allowable resource blocks to a fourth number of allowable resource blocks; and means for determining the target number of total resource blocks to be the third number of resource blocks and the target number of allowable resource blocks to be the fourth number of allowable resource blocks.

In some embodiments, the apparatus further comprises means for in accordance with a determination that the number of successful early data transmission is below the first threshold number, comparing the number of successful early data transmission with a second threshold number, the second threshold number being smaller than the first threshold number; and means for in accordance with a determination that the number of successful early data transmission is below the second threshold number, increasing the second number of allowable resource blocks to a fifth number of allowable resource blocks; and means for determining the target number of total resource blocks to be the third number of resource blocks and the target number of allowable resource blocks to be the fifth number of allowable resource blocks.

In some embodiments, the apparatus further comprises means for in accordance with a determination that the number of successful early data transmission is below the first threshold number, comparing the number of successful early data transmission with a second threshold number, the second threshold number being smaller than the first threshold number; and means for in accordance with a determination that the number of successful early data transmission exceeds the second threshold number, determining the target number of total resource blocks to be the third number of resource blocks and the target number of allowable resource blocks to be the second number of allowable resource blocks.

In some embodiments, the means for determining the second configuration information comprises: means for transmitting third configuration information for early data transmission, the third configuration information indicating a sixth number of total resource blocks to be used by the second for the early data transmission and a seventh number of allowable resource blocks; means for receiving from the third device further usage information of the resource blocks; and means for determining the second configuration information based on correlation between the usage information and the further usage information.

In some embodiments, the apparatus further comprises means for transmitting an update request for the first configuration information to the third device; and means for receiving a response to the update request; and means for in accordance with a determination the response indicating acknowledgement, transmitting the second configuration information to the third device.

In some embodiments, the first device comprises a manager device, the second device comprises a terminal device and the third device comprises a network device.

In some embodiments, an apparatus for performing the method 1000 (for example, the third device 130) may comprise respective means for performing the corresponding steps in the method 1000. These means may be implemented in any suitable manners. For example, it can be implemented by circuitry or software modules.

In some embodiments, the apparatus comprises means for transmitting to a second device first configuration information for early data transmission received from a first device, the first configuration information indicating a first number of total resource blocks to be used by the second device for the early data transmission and a second number of allowable resource blocks; means for receiving the early data transmission from the second device; means for generating usage information of the total resource blocks based at least on the early data transmission; and means for transmitting the usage information to the first device.

In some embodiments, the usage information comprises one or more of: the number of total early data transmissions during a period of time, the number of successful early data transmissions during the period of time, the number of hybrid automatic repeat request, HARQ, processes during the period of time, and the number of resource blocks used by the second device during the period of time.

In some embodiments, the apparatus further comprises means for receiving an update request for the first configuration from the first device; means for generating a response to the update request based on a capacity of the third device; and means for transmitting the response to the first device.

In some embodiments, the apparatus comprises means for in accordance with a determination that the response indicates an acknowledgment, receiving second configuration information based at least on the usage information and the first configuration information, the second configuration information indicating a target number of total resource blocks and a target number of allowable resource blocks.

In some embodiments, the means for transmitting the first configuration information comprises: means for determining a repetition pattern comprising a plurality of time slots for the early data transmission and a plurality of available resource blocks; and means for transmitting the first configuration information along with the repetition pattern.

In some embodiments, the means for generating the usage information of the resource blocks comprises: means for receiving a buffer status report from the second device; and means for generating the usage information of the resource blocks based on the buffer status report and the early data transmission.

In some embodiments, the first device comprises a manager device, the second device comprises a terminal device and the third device comprises a network device.

In some embodiments, an apparatus for performing the method 1100 (for example, the second device 120-1) may comprise respective means for performing the corresponding steps in the method 1100. These means may be implemented in any suitable manners. For example, it can be implemented by circuitry or software modules.

In some embodiments, the apparatus comprises means for receiving, at a second device and from a third device, first configuration information for early data transmission, the first configuration information indicating a first number of total resource blocks to be used by the second device for the early data transmission and a second number of allowable resource blocks; means for in accordance with a determination that data is to be transmitted, determining whether the data is suitable for the early data transmission based on an amount of the data and the first number of total resource blocks; and means for in accordance the data is suitable for the early data transmission, transmitting the data to the third device based on the first configuration information.

In some embodiments, the means for receiving the first configuration information comprises: means for receiving the first configuration information along with a repetition pattern comprising a plurality of time slots for the early data transmission and a plurality of available resource blocks; and means for performing the early data transmission based on the first configuration and the repletion pattern.

In some embodiments, the second device comprises a terminal device and the third device comprises a network device.

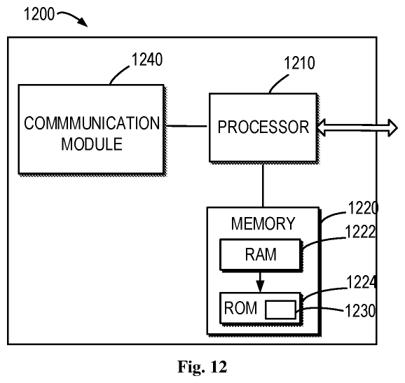

FIG. 12 is a simplified block diagram of a device 1200 that is suitable for implementing embodiments of the present disclosure. The device 1200 may be provided to implement the communication device, for example the first device 110, the second device 120-1, or the third device 130 as shown in FIG. 1. As shown, the device 1200 includes one or more processors 1210, one or more memories 1220 coupled to the processor 1210, and one or more communication modules 1240 coupled to the processor 1210.

The communication module 1240 is for bidirectional communications. The communication module 1240 has at least one antenna to facilitate communication. The communication interface may represent any interface that is necessary for communication with other network elements.

The processor 1210 may be of any type suitable to the local technical network and may include one or more of the following: general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

The memory 1220 may include one or more non-volatile memories and one or more volatile memories. Examples of the non-volatile memories include, but are not limited to, a Read Only Memory (ROM) 1224, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1222 and other volatile memories that will not last in the power-down duration.

A computer program 1230 includes computer executable instructions that are executed by the associated processor 1210. The program 1230 may be stored in the ROM 1224. The processor 1210 may perform any suitable actions and processing by loading the program 1230 into the RAM 1222.

The embodiments of the present disclosure may be implemented by means of the program 1220 so that the device 1200 may perform any process of the disclosure as discussed with reference to FIGS. 2 and 11. The embodiments of the present disclosure may also be implemented by hardware or by a combination of software and hardware.

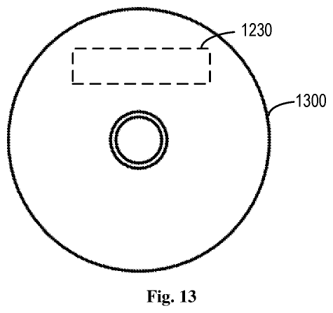

In some example embodiments, the program 1230 may be tangibly contained in a computer readable medium which may be included in the device 1200 (such as in the memory 1220) or other storage devices that are accessible by the device 1200. The device 1200 may load the program 1230 from the computer readable medium to the RAM 1222 for execution. The computer readable medium may include any types of tangible non-volatile storage, such as ROM, EPROM, a flash memory, a hard disk, CD, DVD, and the like. FIG. 13 shows an example of the computer readable medium 1300 in form of CD or DVD. The computer readable medium has the program 1230 stored thereon.

It should be appreciated that future networks may utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications, this may mean node operations to be carried out, at least partly, in a central/centralized unit, CU, (e.g. server, host or node) operationally coupled to distributed unit, DU, (e.g. a radio head/node). It is also possible that node operations will be distributed among a plurality of servers, nodes or hosts. It should also be understood that the distribution of labor between core network operations and base station operations may vary depending on implementation.

In an embodiment, the server may generate a virtual network through which the server communicates with the distributed unit. In general, virtual networking may involve a process of combining hardware and software network resources and network functionality into a single, software-based administrative entity, a virtual network. Such virtual network may provide flexible distribution of operations between the server and the radio head/node. In practice, any digital signal processing task may be performed in either the CU or the DU and the boundary where the responsibility is shifted between the CU and the DU may be selected according to implementation.

Therefore, in an embodiment, a CU-DU architecture is implemented. In such case the device 1200 may be comprised in a central unit (e.g. a control unit, an edge cloud server, a server) operatively coupled (e.g. via a wireless or wired network) to a distributed unit (e.g. a remote radio head/node). That is, the central unit (e.g. an edge cloud server) and the distributed unit may be stand-alone apparatuses communicating with each other via a radio path or via a wired connection. Alternatively, they may be in a same entity communicating via a wired connection, etc. The edge cloud or edge cloud server may serve a plurality of distributed units or a radio access networks. In an embodiment, at least some of the described processes may be performed by the central unit. In another embodiment, the device 1200 may be instead comprised in the distributed unit, and at least some of the described processes may be performed by the distributed unit.

In an embodiment, the execution of at least some of the functionalities of the device 1200 may be shared between two physically separate devices (DU and CU) forming one operational entity. Therefore, the apparatus may be seen to depict the operational entity comprising one or more physically separate devices for executing at least some of the described processes. In an embodiment, such CU-DU architecture may provide flexible distribution of operations between the CU and the DU. In practice, any digital signal processing task may be performed in either the CU or the DU and the boundary where the responsibility is shifted between the CU and the DU may be selected according to implementation. In an embodiment, the device 1200 controls the execution of the processes, regardless of the location of the apparatus and regardless of where the processes/functions are carried out.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 900-1100 as described above with reference to FIGS. 9-11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method, comprising:
obtaining, at a first device, first configuration information for early data transmission, the first configuration information indicating a first number of total resource blocks to be used by a second device for the early data transmission and a second number of allowable resource blocks;
transmitting, at the first device, the first configuration information to a third device;
receiving, at the first device, usage information of the total resource blocks from the third device; and
determining, at the first device, second configuration information based at least on the usage information and the first configuration information, the second configuration information indicating a target number of total resource blocks and a target number of allowable resource blocks.

2. The method of claim 1, wherein the usage information comprises one or more of:
the number of total early data transmissions during a period of time,
the number of successful early data transmissions during the period of time,
the number of hybrid automatic repeat request, HARQ, processes during the period of time, and
the number of resource blocks used by the second device during the period of time.

3. The method of claim 1, wherein determining the second configuration information comprises:
determining, at the first device, a third number of resource blocks used by the second device based on the usage information;
comparing, at the first device, the third number of resource blocks with the first number of total resource blocks; and
in accordance that the third number of resource blocks is different from the first number of total resource blocks, determining, at the first device, that the target number of total resource blocks to be the third number of resource blocks.

4. The method of claim 1, wherein determining the second configuration information comprises:
determining, at the first device, a third number of resource blocks used by the second device based on the usage information;
comparing, at the first device, the third number of resource blocks with the first number of total resource blocks;
in accordance that the third number of resource blocks is the same as the first number of total resource blocks, determining, at the first device, the number of successful early data transmission based on the usage information;
comparing, at the first device, the number of successful early data transmission with a first threshold number;
in accordance with a determination that the number of successful early data transmission exceeds the first threshold number, decreasing, at the first device, the second number of allowable resource blocks to a fourth number of allowable resource blocks; and
determining, at the first device, the target number of total resource blocks to be the third number of resource blocks and the target number of allowable resource blocks to be the fourth number of allowable resource blocks.

5. The method of claim 4, further comprising:
in accordance with a determination that the number of successful early data transmission is below the first threshold number, comparing, at the first device, the number of successful early data transmission with a second threshold number, the second threshold number being smaller than the first threshold number; and
in accordance with a determination that the number of successful early data transmission is below the second threshold number, increasing, at the first device, the second number of allowable resource blocks to a fifth number of allowable resource blocks; and
determining, at the first device, the target number of total resource blocks to be the third number of resource blocks and the target number of allowable resource blocks to be the fifth number of allowable resource blocks.

6. The method of claim 4, further comprising:
in accordance with a determination that the number of successful early data transmission is below the first threshold number, comparing, at the first device, the number of successful early data transmission with a second threshold number, the second threshold number being smaller than the first threshold number; and
in accordance with a determination that the number of successful early data transmission exceeds the second threshold number, determining, at the first device, the target number of total resource blocks to be the third number of resource blocks and the target number of allowable resource blocks to be the second number of allowable resource blocks.

7. The method of claim 1, wherein determining the second configuration information comprises:
transmitting, at the first device, third configuration information for early data transmission, the third configuration information indicating a sixth number of total resource blocks to be used by the second for the early data transmission and a seventh number of allowable resource blocks;
receiving, at the first device and from the third device, further usage information of the resource blocks;
determining, at the first device, the second configuration information based on correlation between the usage information and the further usage information.

8. A method, comprising:
transmitting, at a third device and to a second device, first configuration information for early data transmission received from a first device, the first configuration information indicating a first number of total resource blocks to be used by the second device for the early data transmission and a second number of allowable resource blocks;
receiving, at the third device, the early data transmission from the second device;
generating, at the third device, usage information of the total resource blocks based at least on the early data transmission; and
transmitting, at the third device, the usage information to the first device.

9. The method of claim 8, wherein the usage information comprises one or more of:
the number of total early data transmissions during a period of time,
the number of successful early data transmissions during the period of time,
the number of hybrid automatic repeat request, HARQ, processes during the period of time, and
the number of resource blocks used by the second device during the period of time.

10. The method of claim 8, further comprising:
receiving, at the third device, an update request for the first configuration from the first device;
generating, at the third device, a response to the update request based on a capacity of the third device;
transmitting, at the third device, the response to the first device; and
in accordance with a determination that the response indicates an acknowledgment, receiving, at the third device, second configuration information based at least on the usage information and the first configuration information, the second configuration information indicating a target number of total resource blocks and a target number of allowable resource blocks.

11. The method of claim 8, wherein generating the usage information of the resource blocks comprises:
receiving a buffer status report from the second device; and
generating the usage information of the resource blocks based on the buffer status report and the early data transmission.

12. A method, comprising:
receiving, at a second device and from a third device, first configuration information for early data transmission, the first configuration information indicating a first number of total resource blocks to be used by the second device for the early data transmission and a second number of allowable resource blocks;
in accordance with a determination that data is to be transmitted, determining, at the second device, whether the data is suitable for the early data transmission based on an amount of the data and the first number of total resource blocks; and
in accordance the data is suitable for the early data transmission, transmitting, at the second device, the data to the third device based on the first configuration information.

13. The method of claim 12, wherein receiving the first configuration information comprises:
receiving, at the second device, the first configuration information along with a repetition pattern comprising a plurality of time slots for the early data transmission and a plurality of available resource blocks; and
performing, at the second device, the early data transmission based on the first configuration and the repletion pattern.

14. A first device, comprising:
at least one processor; and
at least one memory including computer program code;
wherein the at least one memory and the computer program code are configured to, with the at least one processor, cause the first device to perform the method according to claim 1.

15. A third device, comprising:
at least one processor; and
at least one memory including computer program code;
wherein the at least one memory and the computer program code are configured to, with the at least one processor, cause the third device to perform the method according to claim 8.

16. A second device, comprising:
at least one processor; and
at least one memory including computer program codes;
the at least one memory and the computer program codes are configured to, with the at least one processor, cause the second device to perform the method according to claim 12.

17. A computer program embodied on a non-transitory computer-readable storage medium, said computer program comprising program instructions stored thereon, the instructions, when executed by an apparatus, causing the apparatus to perform the method of claim 1.

18. A computer program embodied on a non-transitory computer-readable storage medium, said computer program comprising program instructions stored thereon, the instructions, when executed by an apparatus, causing the apparatus to perform the method of claim 8.

19. A computer program embodied on a non-transitory computer-readable storage medium, said computer program comprising program instructions stored thereon, the instructions, when executed by an apparatus, causing the apparatus to perform the method of claim 12.
